(19) United States
(12) Patent Application Publication
(10) Pub. No.: US 2026/0211212 A1
(43) Pub. Date: Jul. 23, 2026

(54) OPTICAL DEVICE AND LASER PROCESSING DEVICE

(71) Applicant: Panasonic Intellectual Property Management Co., Ltd., Osaka (JP)

(72) Inventors: IZURU NAKAI, Osaka (JP); YOSHIRO KITAMURA, Osaka (JP); AKIRA KUMAGAWA, Osaka (JP); TOMOYA OKAMOTO, Osaka (JP)

(21) Appl. No.: 19/445,219

(22) Filed: Jan. 9, 2026

(30) Foreign Application Priority Data
Jan. 22, 2025 (JP) 2025-009328

(51) Int. Cl. G02B 7/182; B23K 26/064

(52) U.S. Cl. CPC G02B 7/182; B23K 26/0643

(57) ABSTRACT

Optical device includes: mirror substrate including a reflector that reflects light; a plurality of actuators each including movable end configured to move in a state of being in non-fixed contact with a portion of mirror substrate excluding the reflector; and at least one elastic member that biases mirror substrate toward movable end of each of the plurality of actuators and maintains contact between mirror substrate and movable end of each of the plurality of actuators.

### BACKGROUND

### 1. Technical Field

The present disclosure relates to an optical device that reflects a laser beam and a laser processing device including the optical device.

### 2. Description of the Related Art

Conventionally, a laser processing device that performs laser processing using an optical device that reflects a laser beam has been known. For example, PTL 1 discloses a laser processing device that performs laser cutting using an optical device that reflects a laser beam. The optical device includes a mirror substrate and a plurality of piezoelectric elements (actuators) whose tips are fixed to the mirror substrate to drive the mirror substrate. When each of the plurality of actuators extends and contracts, the mirror substrate is driven.

### CITATION LIST

### Patent Literature

PTL 1: Japanese Patent No. 6,123,469

### SUMMARY

To solve the problem described above, according to an aspect of the present disclosure,
provided is an optical device including:
a mirror substrate including a reflector that reflects light;
a plurality of actuators each including a movable end configured to move in a state of being in non-fixed contact with a portion of the mirror substrate excluding the reflector; and
at least one elastic member that biases the mirror substrate toward the movable end of each of the plurality of actuators and maintains contact between the mirror substrate and the movable end of each of the plurality of actuators.

Further, according to another aspect of the present disclosure,
provided is a laser processing device including:
the optical device described above; and
a laser output device that emits a laser beam toward a reflecting surface of the mirror substrate of the optical device.

### BRIEF DESCRIPTION OF THE DRAWINGS

FIG. 1 is a schematic diagram of a laser processing device according to a first exemplary embodiment of the present disclosure;

FIG. 2 is a perspective view of an optical device according to the first exemplary embodiment;

FIG. 3 is a top view of the optical device according to the first exemplary embodiment;

FIG. 4 is a cross-sectional view of the optical device taken along line A-A illustrated in FIG. 2;

FIG. 5 is a cross-sectional view of the optical device in a state where a mirror substrate is inclined by a plurality of actuators;

FIG. 6 is a diagram illustrating a trajectory of a laser spot during wobbling welding;

FIG. 7 is a perspective view of an optical device according to a second exemplary embodiment of the present disclosure;

FIG. 8 is a cross-sectional view of the optical device taken along line B-B illustrated in FIG. 7;

FIG. 9 is a top view of an optical device according to a third exemplary embodiment of the present disclosure;

FIG. 10 is a cross-sectional view of the optical device taken along line C-C illustrated in FIG. 9;

FIG. 11 is a cross-sectional view of an optical device according to a fourth exemplary embodiment of the present disclosure;

FIG. 12 is a cross-sectional view of an optical device according to a fifth exemplary embodiment of the present disclosure; and

FIG. 13 is a schematic diagram of an optical device according to a sixth exemplary embodiment of the present disclosure.

### DETAILED DESCRIPTIONS

In the case of the laser processing device described in PTL 1, the actuator extends and contracts to push and pull the mirror substrate. When the actuator pulls the mirror substrate, tensile stress is generated in a fixed part between the mirror substrate and the actuator. When the actuator repeatedly extends and contracts at a high speed, tensile stress is repeatedly generated in a fixed part between the mirror substrate and the actuator. Due to the repeated tensile stress, there is a possibility that the fixed part finally undergoes fatigue fracture and the mirror substrate and the actuator are separated.

Therefore, an object of the present disclosure is to continuously maintain contact between a mirror substrate and actuators in an optical device that drives the mirror substrate reflecting light by the actuators.

Hereinafter, exemplary embodiments will be described in detail with reference to the drawings as appropriate. However, unnecessarily detailed description may be omitted. For example, a detailed description of a well-known matter and a repeated description of substantially the same configuration may be omitted. This is to avoid unnecessary redundancy of the following description and to facilitate understanding of those skilled in the art.

Note that the inventor(s) provides the accompanying drawings and the following description in order for those skilled in the art to fully understand the present disclosure, and does not intend to limit the subject matter described in the claims by the accompanying drawings and the following description.

Hereinafter, an imaging device according to an exemplary embodiment of the present disclosure will be described with reference to the drawings.

### First Exemplary Embodiment

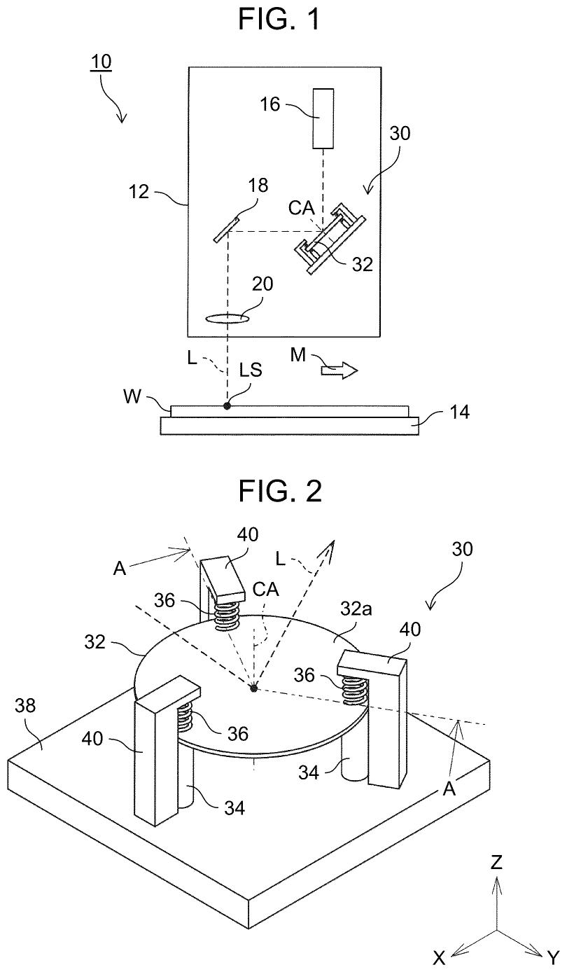

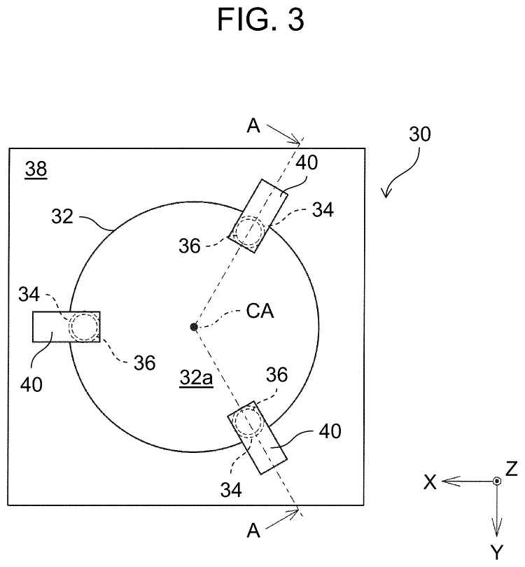

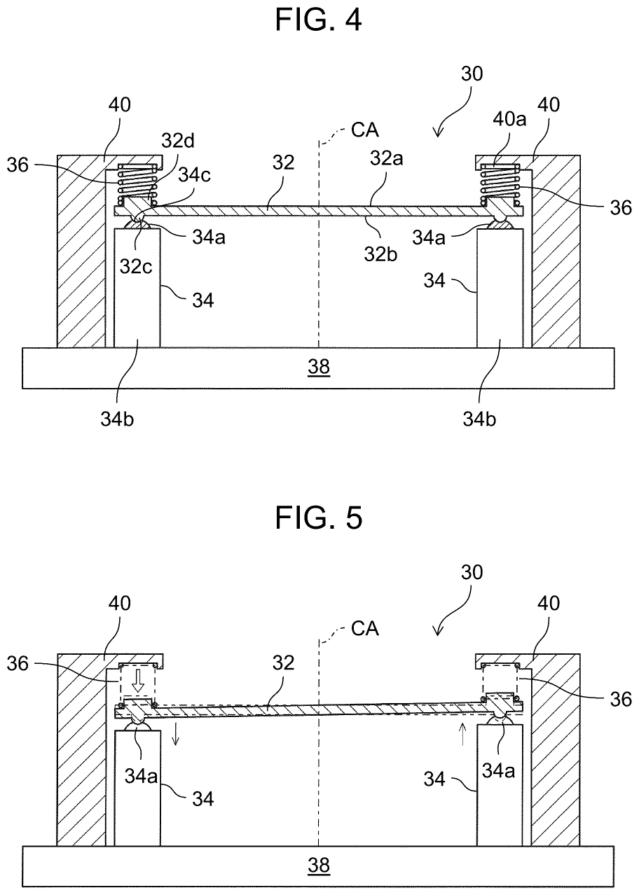

FIG. 1 is a schematic diagram of a laser processing device according to a first exemplary embodiment of the present disclosure. FIG. 2 is a perspective view of the optical device according to the first exemplary embodiment. FIG. 3 is a top view of the optical device according to the first exemplary embodiment. FIG. 4 is a cross-sectional view of the optical device taken along line A-A illustrated in FIG. 2. Note that the X-Y-Z orthogonal coordinate system illustrated in the drawings is for facilitating understanding of the present disclosure, and does not limit the present disclosure. Although described in detail later, the Z-axis direction is an extending direction of the reference axis CA of the optical device, and the X-axis direction and the Y-axis direction are directions intersecting with the reference axis CA.

As illustrated in FIG. 1, laser processing device 10 according to the first exemplary embodiment is a laser welding device that performs laser welding on workpiece W, and includes welding head 12 that moves relative to workpiece W and stage 14 on which workpiece W is set. For example, welding head 12 moves relative to stage 14, or stage 14 moves relative to welding head 12.

Welding head 12 of laser processing device 10 includes laser output device 16 that emits laser beam L, mirror substrate 18 that reflects laser beam L, and lens 20 that condenses laser beam L. In addition, optical device 30 that reflects laser beam L from laser output device 16 toward mirror substrate 18 is disposed on an optical path between laser output device 16 and mirror substrate 18.

As illustrated in FIGS. 2 to 4, optical device 30 includes mirror substrate 32 that reflects laser beam L, a plurality of actuators 34 that drive mirror substrate 32, a plurality of elastic members 36 that bias mirror substrate 32, and base member 38.

Mirror substrate 32 includes reflecting surface 32a and back surface 32b opposite to reflecting surface 32a. Mirror substrate 32 is made, for example, by forming a dielectric film on one surface of a glass substrate having a thickness of 5 mm to 10 mm and a diameter of 25 mm to 150 mm. Mirror substrate 32 may be formed by applying mirror coating to one surface of a metal substrate such as silicon or aluminum. In addition, mirror substrate 32 may have a hollow structure, for example, a honeycomb structure in order to reduce the weight as long as mirror substrate 32 includes flat reflecting surface 32a.

The plurality of actuators 34 are actuators that drive mirror substrate 32, specifically, tilt mirror substrate 32 to change the reflection direction of laser beam L, and in the present exemplary embodiment, three actuators are provided as illustrated in FIG. 3. Reference axis CA extends in the normal direction of reflecting surface 32a and passes through the center of mirror substrate 32 when actuators 34 do not drive mirror substrate 32 and mirror substrate 32 is not inclined. The plurality of actuators 34 are annularly arranged at regular intervals so as to surround reference axis CA (that is, the center of mirror substrate 32) as viewed in the extending direction (Z-axis direction) of reference axis CA. Thus, in the first exemplary embodiment, mirror substrate 32 is supported at three points by the plurality of actuators 34.

Each of the plurality of actuators 34 includes movable end 34a in contact with back surface 32b of mirror substrate 32, and fixed end 34b fixed to base member 38. That is, the plurality of actuators 34 are disposed in a space between mirror substrate 32 and base member 38. Further, in the case of the first exemplary embodiment, each of the plurality of actuators 34 is a piezoelectric actuator configured by laminating a plurality of piezoelectric elements. By controlling the applied voltage of the piezoelectric element, actuator 34 extends and contracts in the extending direction of reference axis CA (Z-axis direction), and movable end 34a moves in the extending direction of reference axis CA. In other words, the extending direction of reference axis CA is the moving direction of movable end 34a of actuator 34. Note that the actuator of the present disclosure is not limited to the piezoelectric actuator, and may be any actuator having a movable end capable of reciprocating in one direction.

Movable end 34a of each of the plurality of actuators 34 moves in a state of being in non-fixed contact with back surface 32b of mirror substrate 32. The term “non-fixed” as used herein refers to a state in which movable end 34a is not bonded to mirror substrate 32 and mirror substrate 32 can be separated from movable end 34a in a non-destructive manner. Therefore, mirror substrate 32 can be separated from movable end 34a of actuator 34 in the moving direction (Z-axis direction) of movable end 34a.

In the first exemplary embodiment, the plurality of elastic members 36 are coil springs, and bias mirror substrate 32 toward movable ends 34a of the plurality of actuators 34, respectively. The reason of the above is described.

FIG. 5 is a cross-sectional view of the optical device in a state where the mirror substrate is inclined by a plurality of actuators.

As described above, movable end 34a of each of the plurality of actuators 34 is not fixed to mirror substrate 32. When movable end 34a of actuator 34 moves forward (when actuator 34 extends), movable end 34a and mirror substrate 32 can continue to be in contact with each other, so that actuator 34 can push mirror substrate 32. On the other hand, when movable end 34a retracts (when actuator 34 contracts), movable end 34a is separated from mirror substrate 32, so that actuator 34 cannot pull mirror substrate 32.

Each of the plurality of elastic members 36 continues to bias mirror substrate 32 toward corresponding movable end 34a in order to maintain contact between the movable end 34a of actuator 34 and mirror substrate 32 when the movable end 34a retracts. Therefore, when movable end 34a of actuator 34 retreats, the portion of mirror substrate 32 facing the movable end 34a is also displaced by the same displacement amount as the movement amount of the movable end 34a. Therefore, by controlling the movement amount of movable ends 34a of the plurality of actuators 34, the inclination of mirror substrate 32 can be reliably controlled.

In the case of the first exemplary embodiment, the plurality of elastic members 36 bias reflecting surface 32a of mirror substrate 32, specifically, the outer peripheral side portion of reflecting surface 32a except for the central portion of reflecting surface 32a on which laser beam L strikes. In the first exemplary embodiment, each of the plurality of elastic members 36 is received by a plurality of retainer members 40 having an inverted “L” shape extending from base member 38 to a position facing reflecting surface 32a of mirror substrate 32. That is, the plurality of elastic members 36 are disposed in a compressed and deformed state between corresponding retainer member 40 and mirror substrate 32. As illustrated in FIG. 4, each retainer member 40 is formed with recess 40a that accommodates a part of elastic member 36.

In the first exemplary embodiment, as illustrated in FIGS. 2 and 4, a plurality of actuators 34 and a plurality of elastic members 36 sandwich mirror substrate 32. Specifically, the plurality of actuators 34 are disposed on back surface 32b side with respect to mirror substrate 32 (that is, one side in the moving direction (Z-axis direction) of movable end 34a of actuator 34), and the plurality of elastic members 36 are disposed on reflecting surface 32a side with respect to mirror substrate 32 (the other side in the moving direction of movable end 34a of actuator 34). As a result, mirror substrate 32 is movably held.

In the case of the first exemplary embodiment, as illustrated in FIGS. 3 and 4, the number of the plurality of elastic members 36 is the same as the number of the plurality of actuators 34. Each of the plurality of elastic members 36 faces movable end 34a of corresponding actuator 34 across mirror substrate 32 in the extending direction (Z-axis direction) of reference axis CA, that is, in the moving direction of movable end 34a. As a result, corresponding actuator 34 supports the portion of mirror substrate 32 biased by elastic member 36. As a result, the bending deformation of mirror substrate 32 due to the biasing of elastic member 36 is suppressed.

Furthermore, in the case of the first exemplary embodiment, the movement of mirror substrate 32 sandwiched between the plurality of actuators 34 and the plurality of elastic members 36 in the direction intersecting reference axis CA (X-axis direction, Y-axis direction) is restricted.

Specifically, in the first exemplary embodiment, a plurality of hemispherical projections 32c are provided on back surface 32b of mirror substrate 32, and curved recess 34c with which corresponding hemispherical projection 32c rotatably engages is provided on movable end 34a of actuator 34. Consequently, actuator 34 restricts the movement of mirror substrate 32 in the direction intersecting reference axis CA. Projections 32c may be provided integrally with mirror substrate 32, or may be a separate member bonded to mirror substrate 32. Alternatively, recesses may be provided in mirror substrate 32, and a projection may be provided in actuator 34.

In the case of the first exemplary embodiment, reflecting surface 32a of mirror substrate 32 is provided with a plurality of projections 32d that enter a plurality of elastic members 36 (coil spring), respectively. Thus, elastic member 36 restricts the movement of mirror substrate 32 in the direction intersecting reference axis CA (X-axis direction, Y-axis direction). Alternatively, mirror substrate 32 may be provided with recesses each of which accommodates a part of elastic member 36 similar to recess 40a of retainer member 40.

The method for restricting the movement of mirror substrate 32 in the direction intersecting reference axis CA (X-axis direction, Y-axis direction) is not limited to the above method, and may be a method other than the above method.

In addition, for example, in a case where optical device 30 is used in a posture in which reference axis CA extends in the vertical direction, that is, in a case where mirror substrate 32 cannot move in the direction intersecting reference axis CA (X-axis direction, Y-axis direction) due to sandwiching between the plurality of actuators 34 and the plurality of elastic members 36, the movement of mirror substrate 32 in the direction intersecting reference axis CA (X-axis direction, Y-axis direction) may not be restricted.

However, considering that mirror substrate 32 is inclined without deforming mirror substrate 32, it is preferable that movable end 34a of actuator 34 and mirror substrate 32 avoid planar contact via a large contact surface. That is, it is preferable that each of movable ends 34a of the plurality of actuators 34 and mirror substrate 32 be brought into contact with each other via curved surface contact or point contact between hemispherical projection 32c and curved recess 34c or point contact between the hemispherical projection and the plane.

By using such optical device 30, laser processing device 10 illustrated in FIG. 1 can perform wobbling welding.

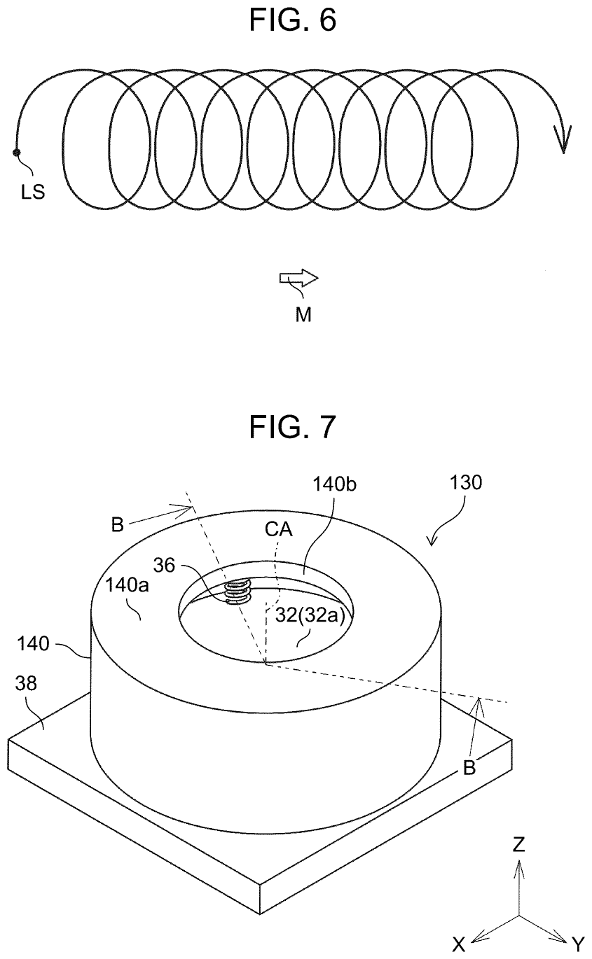

FIG. 6 is a diagram illustrating a trajectory of a laser spot during wobbling welding.

During wobbling welding, the plurality of actuators 34 of optical device 30 continuously change the inclination direction of mirror substrate 32 such that the normal vector of reflecting surface 32a of mirror substrate 32 rotates about reference axis CA in a state where the normal vector is inclined with respect to reference axis CA. In this state, when welding head 12 moves relative to workpiece W in the direction of arrow M illustrated in FIG. 1, a trajectory of laser spot LS as illustrated in FIG. 6 is obtained. For that purpose, during wobbling welding, each of the plurality of actuators 34 reciprocates movable end 34a in the same cycle and in a state of phase shift.

According to the first exemplary embodiment as described above, in the optical device in which the actuators drive the mirror substrate that reflects the laser beam, the contact between the mirror substrate and the actuators can be continuously maintained.

Specifically, movable end 34a of actuator 34 and mirror substrate 32 are not fixed to each other, and contact between movable end 34a and mirror substrate 32 is maintained by elastic member 36. Therefore, the fatigue fracture of the fixed part due to the repeated generation of the tensile stress in the fixed part at the time of pulling mirror substrate 32, which occurs when actuator 34 and mirror substrate 32 are fixed to each other, does not occur between mirror substrate 32 and actuator 34 of the first exemplary embodiment. Therefore, in the first exemplary embodiment, the contact between mirror substrate 32 and movable ends 34a can be continuously maintained.

### Second Exemplary Embodiment

The present second exemplary embodiment is an improved embodiment of the first exemplary embodiment described above. Therefore, the second exemplary embodiment will be described focusing on a point different from the above-described first exemplary embodiment. Note that constituent elements according to the present second exemplary embodiment that are substantially the same as the constituent elements according to the above-described first exemplary embodiment are denoted by the same reference numerals.

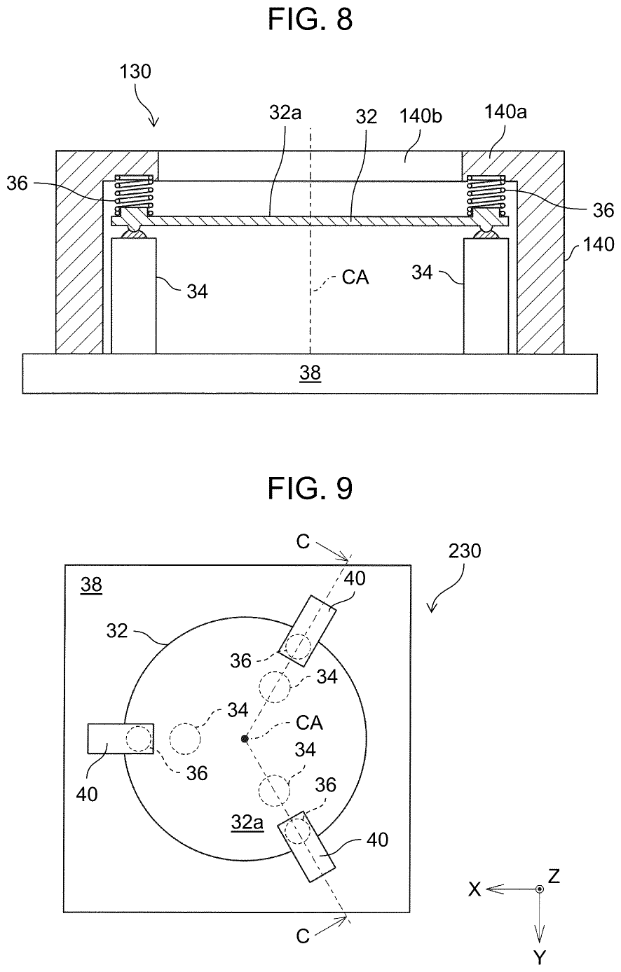

FIG. 7 is a perspective view of an optical device according to the second exemplary embodiment of the present disclosure. FIG. 8 is a cross-sectional view of the optical device taken along line B-B illustrated in FIG. 7.

As illustrated in FIGS. 7 and 8, optical device 130 according to the second exemplary embodiment also includes a plurality of elastic members 36 similarly to optical device 30 according to the first exemplary embodiment described above. In the case of the above-described first exemplary embodiment, retainer member 40 corresponding to each of elastic members 36 is provided. That is, in the case of the above-described first exemplary embodiment, the number of elastic members 36 and the number of retainer members 40 are the same. On the other hand, in the case of the second exemplary embodiment, optical device 130 includes one retainer member 140 common to the plurality of elastic members 36. Retainer member 140 is a bottomed cylindrical member, and has bottom portion 140a provided with through hole 140b through which reflecting surface 32a of mirror substrate 32 is exposed, that is, through which laser beam L passes. The plurality of elastic members 36 are disposed in a compressed state between bottom portion 140a of retainer member 140 and mirror substrate 32. Mirror substrate 32 and a plurality of actuators 34 are stored in tubular retainer member 140.

Also in the second exemplary embodiment, similarly to the first exemplary embodiment, in the optical device in which the mirror substrate that reflects the laser beam is driven by the actuators, the contact between the mirror substrate and the actuators can be continuously maintained.

### Third Exemplary Embodiment

In the case of the above-described first exemplary embodiment, each of the plurality of actuators 34 faces corresponding elastic member 36 across mirror substrate 32 in the moving direction (Z-axis direction) of movable end 34a of actuator 34. However, the third exemplary embodiment is different from this. Therefore, the third exemplary embodiment will be described focusing on a point different from the above-described first exemplary embodiment. Note that constituent elements of the third exemplary embodiment substantially the same as the constituent elements of the first exemplary embodiment described above are denoted by the same reference numerals.

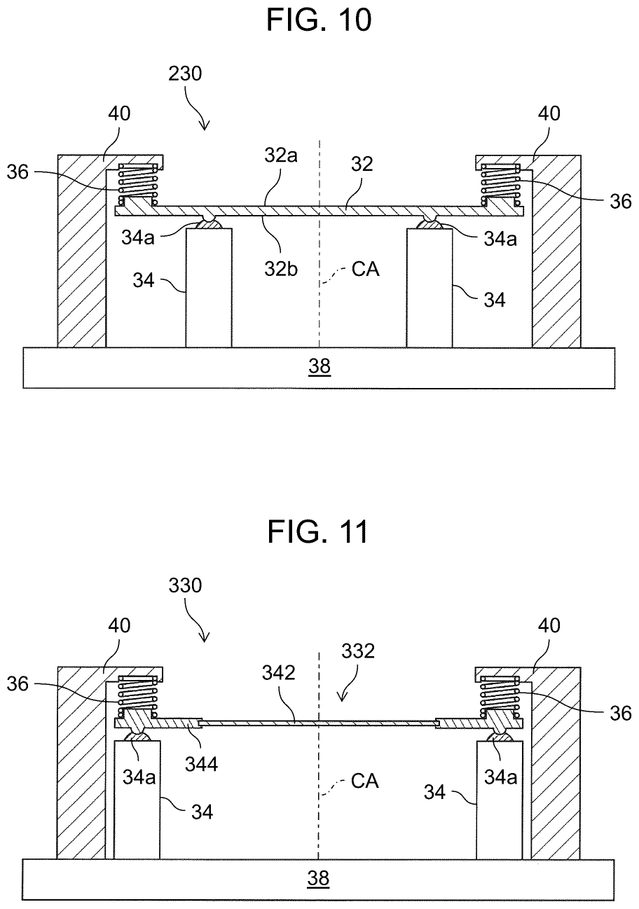

FIG. 9 is a top view of an optical device according to the third exemplary embodiment of the present disclosure. FIG. 10 is a cross-sectional view of the optical device taken along line C-C illustrated in FIG. 9.

As illustrated in FIGS. 9 and 10, in the case of optical device 230 according to the third exemplary embodiment, each of the plurality of actuators 34 does not face elastic member 36 in the moving direction (Z-axis direction) of movable end 34a of actuator 34. In the case of the third exemplary embodiment, the plurality of actuators 34 are annularly arranged at regular intervals so as to surround reference axis CA (that is, the center of mirror substrate 32) as viewed in the extending direction of reference axis CA (as viewed in the moving direction of movable end 34a of actuator 34 (as viewed in the Z-axis direction)). The plurality of elastic members 36 are annularly arranged at regular intervals so as to surround the plurality of actuators 34. Each actuator 34 is disposed between elastic member 36 and reference axis CA.

Therefore, in the case of optical device 230 according to the third exemplary embodiment, the plurality of actuators 34 are disposed near reference axis CA (that is, the center of mirror substrate 32). Consequently, mirror substrate 32 can largely be tilted as compared with the case that the plurality of actuators 34 are remote from reference axis CA. Thus, for example, as illustrated in FIG. 6, when the laser processing device performs wobbling welding, welding can be performed with a wide welding mark.

Also in the third exemplary embodiment, similarly to the first exemplary embodiment described above, in an optical device in which a mirror substrate that reflects a laser beam is driven by actuators, contact between the mirror substrate and the actuators can be continuously maintained.

### Fourth Exemplary Embodiment

The fourth exemplary embodiment is an improvement of the first exemplary embodiment described above. Therefore, the fourth exemplary embodiment will be described focusing on a point different from the above-described first exemplary embodiment. Note that constituent elements according to the fourth exemplary embodiment substantially the same as the constituent elements according to the first exemplary embodiment described above are denoted by the same reference numerals.

FIG. 11 is a cross-sectional view of an optical device according to the fourth exemplary embodiment of the present disclosure.

As illustrated in FIG. 11, in the case of optical device 330 according to the fourth exemplary embodiment, mirror substrate 332 includes reflection member 342 having a reflector that reflects light, and holder 344 that holds an outer peripheral edge of reflection member 342. Holder 344 holds reflection member 342 such that the reflector that reflects the laser beam is exposed. Movable ends 34a of the plurality of actuators 34 are in non-fixed contact with holder 344, and the plurality of elastic members 36 bias holder 344 toward movable ends 34a of the plurality of actuators 34.

Also in the fourth exemplary embodiment, similarly to the first exemplary embodiment described above, in an optical device in which a mirror substrate that reflects a laser beam is driven by actuators, contact between the mirror substrate and the actuators can be continuously maintained.

### Fifth Exemplary Embodiment

The fifth exemplary embodiment is an improvement of the second exemplary embodiment described above. Therefore, the fifth exemplary embodiment will be described focusing on a point different from the second exemplary embodiment described above. Note that constituent elements according to the fifth exemplary embodiment substantially the same as the constituent elements according to the second exemplary embodiment described above are denoted by the same reference numerals.

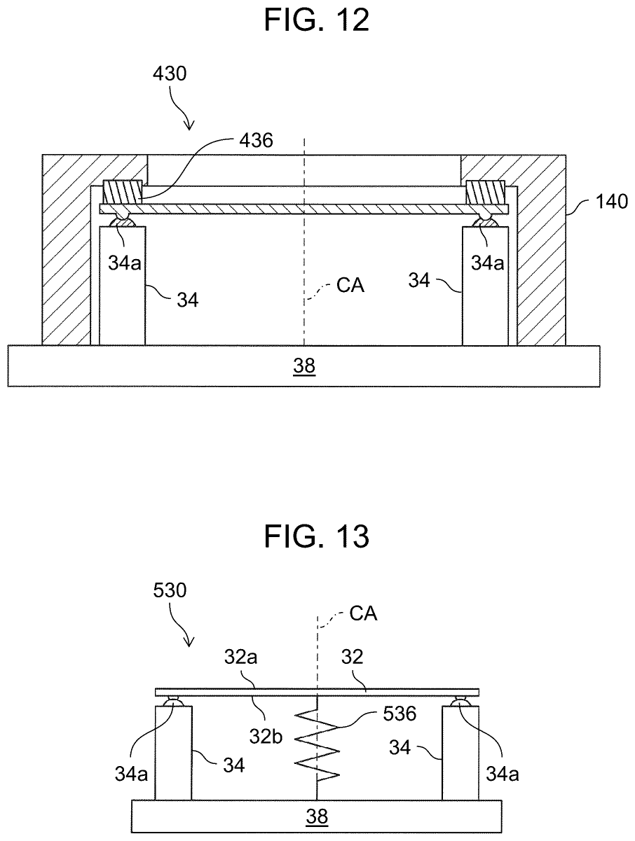

FIG. 12 is a cross-sectional view of an optical device according to the fifth exemplary embodiment of the present disclosure.

In the case of optical device 430 according to the fifth exemplary embodiment, the number of elastic members 436 is not the same as the number of actuators 34, and is one. Elastic member 436 is an annular elastic member, and is made of, for example, a sponge material. Annular elastic member 436 is disposed between the outer peripheral side portion of mirror substrate 32 and retainer member 140 and is compressed and deformed. Each of the plurality of actuators 34 faces different portions of annular elastic member 436 across mirror substrate 32 as viewed in the extending direction of reference axis CA (as viewed in the moving direction of movable end 34a of actuator 34).

Also in the fifth exemplary embodiment, similarly to the second exemplary embodiment described above, in an optical device in which a mirror substrate that reflects a laser beam is driven by actuators, contact between the mirror substrate and the actuators can be continuously maintained.

Although the present disclosure has been described above with reference to a plurality of exemplary embodiments, the exemplary embodiments of the present disclosure are not limited thereto.

For example, in the first exemplary embodiment, elastic member 36 presses mirror substrate 32 to bias mirror substrate 32 toward movable end 34a of corresponding one of the plurality of actuators 34. However, the exemplary embodiment of the present disclosure is not limited thereto.

FIG. 13 is a schematic diagram of an optical device according to a sixth exemplary embodiment of the present disclosure.

As illustrated in FIG. 13, in the case of optical device 530 according to the sixth exemplary embodiment, elastic member 536 is a coil spring, and has one end fixed to the central portion of back surface 32b of mirror substrate 32 and the other end fixed to base member 38. Elastic member 536 is disposed between mirror substrate 32 and base member 38 in an extended state. Elastic member 536 pulls mirror substrate 32 toward base member 38, so that mirror substrate 32 keeps in contact with movable end 34a of each of the plurality of actuators 34 disposed between mirror substrate 32 and base member 38.

When the mirror substrate is pulled, one end of the elastic member which is a coil spring, may be fixed to the outer peripheral end of the mirror substrate.

Finally, in the case of the above-described first exemplary embodiment, optical device 30 is used for laser processing device 10 and reflects a laser beam. However, in the exemplary embodiments of the present disclosure, the application of optical device 30 is not limited thereto. The optical device according to the exemplary embodiments of the present disclosure can be used for changing the propagation direction of light.

That is, in a broad sense, an optical device according to exemplary embodiments of the present disclosure is an optical device including: a mirror substrate including a reflector that reflects light; a plurality of actuators each including a movable end movable in a state of being in non-fixed contact with a portion of the mirror substrate excluding the reflector; and at least one elastic member that biases the mirror substrate toward the movable end of each of the plurality of actuators and maintains contact between the mirror substrate and the movable end of each of the plurality of actuators.

As described above, the above-described exemplary embodiments have been described as examples of the technique in the present disclosure. To that end, the drawings and detailed description are provided. Therefore, the components described in the drawings and the detailed description may include not only components essential for solving the problem but also components that are not essential for solving the problem in order to illustrate the above-described technique. Therefore, it should not be immediately recognized that these non-essential components are essential based on the fact that these non-essential components are described in the drawings and the detailed description.

In addition, since the above-described exemplary embodiments are intended to illustrate the technique in the present disclosure, various changes, replacements, additions, omissions, and the like can be made within the scope of the claims or equivalents thereof.

According to the present disclosure, in an optical device in which a mirror substrate that reflects light is driven by actuators, it is possible to continuously maintain contact between the mirror substrate and the actuators.

The present disclosure is applicable to an optical device in which a mirror substrate that reflects light is driven by actuators.

What is claimed is:

1. An optical device comprising:
a mirror substrate including a reflector that reflects light;
a plurality of actuators each including a movable end configured to move in a state of being in non-fixed contact with a portion of the mirror substrate excluding the reflector; and
at least one elastic member that biases the mirror substrate toward the movable end of each of the plurality of actuators and maintains contact between the mirror substrate and the movable end of each of the plurality of actuators.

2. The optical device according to claim 1, wherein
the at least one elastic member is a plurality of elastic members,
the plurality of actuators are arranged on one side in a moving direction of the movable end of each of the plurality of actuators with respect to the mirror substrate, and
the plurality of elastic members are arranged on another side in the moving direction with respect to the mirror substrate.

3. The optical device according to claim 2, wherein each of the plurality of elastic members faces the movable end of a corresponding one of the plurality of actuators across the mirror substrate in the moving direction.

4. The optical device according to claim 2, wherein the plurality of actuators are arranged in an annular shape and the plurality of elastic members are arranged in an annular shape to surround the plurality of actuators as viewed in the moving direction.

5. The optical device according to claim 2, further comprising a common retainer member that receives the plurality of elastic members.

6. The optical device according to claim 2, wherein
a hemispherical projection is provided on one of the movable end of each of the plurality of actuators and a contact portion of the mirror substrate in contact with the movable end, and
a curved recess engaged with the projection is provided on another of the movable end of each of the plurality of actuators and the contact portion of the mirror substrate.

7. The optical device according to claim 2, wherein
the plurality of elastic members are coil springs, and
the mirror substrate is provided with projections that enter the coil springs or recesses that accommodate parts of the coil springs.

8. The optical device according to claim 1, wherein
the mirror substrate includes a reflection member including the reflector and a holder holding an outer peripheral edge of the reflection member,
the movable end of each of the plurality of actuators is in non-fixed contact with the holder, and
the at least one elastic member biases the holder toward the movable end of each of the plurality of actuators.

9. A laser processing device comprising:
the optical device according to claim 1; and
a laser output device that emits a laser beam toward a reflecting surface of the mirror substrate of the optical device.
